(19) United States
(12) Patent Application Publication
(10) Pub. No.: US 2016/0235025 A1
(43) Pub. Date: Aug. 18, 2016

(54) Aeroponic Cultivation System

(71) Applicant: Azoth Solutions, LLC, Seattle, WA (US)

(72) Inventor: Jon Aaron Bray, Seattle, WA (US)

(21) Appl. No.: 15/043,440

(22) Filed: Feb. 12, 2016

Related U.S. Application Data
(60) Provisional application No. 62/116,486, filed on Feb. 15, 2015.

(51) Int. Cl. A01G 31/06; A01G 1/00

(52) U.S. Cl. CPC A01G 31/06; A01G 1/001; A01G 2031/006

(57) ABSTRACT

A vertical aeroponic garden utilizes removable growing panels that support plants undisturbed from germination through harvest. The panels are removable, with the supported plants, and can be delivered to a grocery location for harvest by a consumer. A frame system is configured to support one or more growing panels in a vertical orientation. The growing panels define an aeroponic chamber in which a fluid delivery system supplies a nutrient rich atomized solution to the root structure of the plants.

### CROSS-REFERENCE TO RELATED APPLICATIONS

This application claims priority to provisional application 62/116,486 filed on Feb. 15, 2015 the entirety of which is incorporated herein by reference.

### BACKGROUND

Aeroponics is the process of growing plants in an air environment without a soil or other aggregate medium to provide nutrients to plant roots. The required nutrients are typically supplied to the root system in an aqueous solution through low-pressure or high-pressure sprayers.

In typical aeroponic systems, plants are suspended in an environment with their roots within an aeroponic chamber while the foliage extends outside the aeroponic chamber. A number of nozzles spray atomized water and nutrients on the plant roots.

There are many benefits associated with aeroponic growing of crops; including optimizing air access to the root structure for successful plant growth, minimizing plant to plant contact to alleviate disease transmission, and higher growing density when compared to more traditional methods of cultivation.

Nutrient hydro-atomization is an important consideration, since a water droplet that is too large may saturate the root structure and reduce the amount of available oxygen to the plant, while a water droplet that is too small may facilitate excessive root hair without developing the lateral root structure necessary for water uptake and the extraction of nutrients required for the growth and maturation of the plant.

Accordingly, an aeroponic system is especially susceptible to nozzle failure, which can lead to failure of an entire crop. A nozzle may become clogged, for example, with particulate matter in the aqueous solution or may become suffused by root mass. An aeroponic system will generally require numerous nozzles and even a single nozzle failure can impact a significant portion of the crop.

In addition, most aeroponic systems are designed to arrange plants in a horizontal matrix, thereby requiring a significant amount of horizontal space to provide the necessary room for cultivation and limiting the total light available to the plants. Finally, in many instances, the root structure is destroyed in order to harvest the crops, thereby destroying the plant in the process.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a perspective exploded view illustrating an example aeroponic cultivation system in which a frame supports panels configured to hold plants.

FIG. 2 is a perspective view of a frame configured to support one or more panels of an aeroponic growing system.

FIG. 3 is a perspective view illustrating a plumbing manifold and nozzles.

FIG. 4 is a front elevation view of a panel configured with plant site apertures.

FIG. 5 is a perspective view of a plant sheath configured to engage with the plant site apertures of the panel.

FIG. 6 is a perspective view of a mobile atomizing assembly.

FIG. 7 is a perspective view of a mounting assembly for a frame that allows rotation about two axes of the frame.

### DETAILED DESCRIPTION

This disclosure describes, in part, systems and techniques for aeroponic crop cultivation. In particular, some embodiments of the systems described herein provide for an aeroponic growing system that allow for, among other things, relatively small footprint vertical gardens; removable plant support panels that allow the plant to remain secured to the panel from germination to harvest, even up to the point of sale at a merchant; reliable spray nozzles, including a mobile nozzle assembly, and other features that will become readily apparent by reference to the attached figures and accompanying description.

In particular, an aeroponic system comprises a frame that defines a cuboid having a front, a back, two sides, and a top, the tubular frame defining an interior space. A front panel, a back panel, two side panels and a top panel may be removably secured to the tubular frame to enclose the interior space to create an aeroponic chamber. One or more of the panels, i.e., the front panel, back panel, two side panels, and top panel, are a growing panel having one or more plant site apertures arranged in an array and sized to facilitate the insertion of a plant such that a root of the plant is within the aeroponic chamber and a canopy of the plant is outside the aeroponic chamber. A fluid nozzle is positioned within the aeroponic chamber and is in fluid communication with an aqueous solution and in further fluid communication with a source of compressed air. The nozzle is preferably designed to atomize the aqueous solution into droplets of between about 20 microns and 50 microns by mixing the aqueous solution with the compressed air.

In some embodiments, the compressed air is provided to the nozzle at a pressure above 60 psi measured at the nozzle. In other embodiments, air is provided to the nozzle above 50 psi, or 45 psi in some embodiments. In addition, the aqueous solution may be pressurized for delivery to the nozzle. In some instances, the fluid nozzle may be static within the aeroponic chamber, while in other instances, the fluid nozzle is moveable within the aeroponic chamber. In some embodiments that incorporate a mobile fluid nozzle, there may be provided a row of adjacent frames that cooperate to define a continuous aeroponic chamber within which the mobile fluid nozzle can travel.

A track may be provided that defines a pathway along the row of adjacent frames and the fluid nozzle may be configured to engage the track and travel along the pathway within the aeroponic chamber defined by the row of frames.

A lower frame may be provided and configured to engage with and support the frame. In some cases, the lower frame is configured to work with moving equipment for relocating the lower frame and the frame, such as by providing supports, slots, braces, etc. to receive the forks of a fork lift, pallet jack, or some other form of moving equipment.

Additionally, a vertical growing system is described that includes a first substantially planar growing panel configured with plant site apertures, a second substantially planar growing panel configured with plant site apertures, and a frame having a first side configured to removably support the growing panels in a vertical orientation. The growing panels may be supported on the frame such that they are spaced a horizontal distance away from each other and they cooperate to define an aeroponic chamber in between the panels. Other panels, such as other growing panels or additional panels may be secured to the frame to enclose, or substantially enclose, the aeroponic chamber.

A fluid delivery system may be configured to deliver fluid and air to the aeroponic chamber. The fluid delivery system may include a nozzle configured to atomize the fluid to have a droplet size of between 15 microns and 50 microns. The proper atomization may be done by air pressure above 45 psi, or 50 psi, 60 psi, or 65 psi as measured at the nozzle. This provides for a very fine mist of nutrient rich solution to the roots of the plants within the aeroponic chamber without saturating the root structure. The fluid delivery system may further include a fluid manifold that delivers fluid to more than one nozzle along with an air manifold that delivers compressed air to more than one nozzle. The nozzles may include a pressure regulator for regulating air pressure at the nozzle.

A base frame may be mounted to the frame and provide additional support and mobility to the frame. The base frame may be formed integrally with the frame, or may be selectively attached. In addition, the base frame may include casters or wheels to allow the frame to be rolled around and repositioned within a farm, or at a point of sale. The base frame may alternatively or additionally include a support structure configured to allow moving equipment to securely lift the base frame and the frame, such as fork lifts, pallet jacks, or automated type equipment.

A reservoir may be supported by the base frame and disposed generally beneath the aeroponic chamber so that it may collect condensation falling within the aeroponic chamber. A pressurized fluid source may be in communication with the fluid delivery system. The reservoir may also be in fluid communication with the pressurized fluid source such that the fluid collected within the aeroponic chamber can be recirculated back into the pressurized fluid source.

In some instances, a sheath may be used to support a plant within one of the plant site apertures of the growing panel such that a root of the plant extends within the aeroponic chamber and a canopy of the plant extends outside the aeroponic chamber. The sheath may be formed of a cellular material, such as a closed cell foam that may absorb moisture, thereby allowing the plant to access water.

One such benefit of the described systems and methods is the ability to leave the plant relatively undisturbed from germination to market. For example, a plant may be secured within an aperture of a growing panel in its infancy and left there undisturbed until the plant or the crop from the plant is harvested and sold at the location of a grocer.

Accordingly, this may be accomplished by providing a growing panel having a first side and a second side and configured with plant site apertures extending from the first side to the second side, the apertures configured for supporting a plant. The growing panel may be vertically mounted on a frame, in which the second side of the growing panel may define an aeroponic chamber. A young plant, or a seedling, may be inserted into one of the apertures such that a root of the plant extends within the aeroponic chamber and a canopy of the plant extends outside the aeroponic chamber while the plant is supported by the growing panel. A nutrient rich atomized solution may be applied to the root of the plant within the aeroponic chamber to allow the plant to sprout, grow, and produce.

The growing panel may be removed from the frame and delivered to a merchant with the plant still supported by the growing panel. In addition, the plant may be displayed while remaining in the growing panel while at the merchant's location. In this way, the plant continues to grow and produce even while on display at a merchant's location such that a consumer can purchase the entire living plant, or harvest the crop at the point of sale, thus providing the freshest farm-grown produce available.

The nutrient rich atomized solution may be applied to the plant roots by spraying a nutrient rich solution through a nozzle at a pressure of above about 60 psi to form droplets smaller than 50 microns. Once the plant is sold or the crop is harvested, the growing panel may be cleaned or sterilized and reused for growing additional plants.

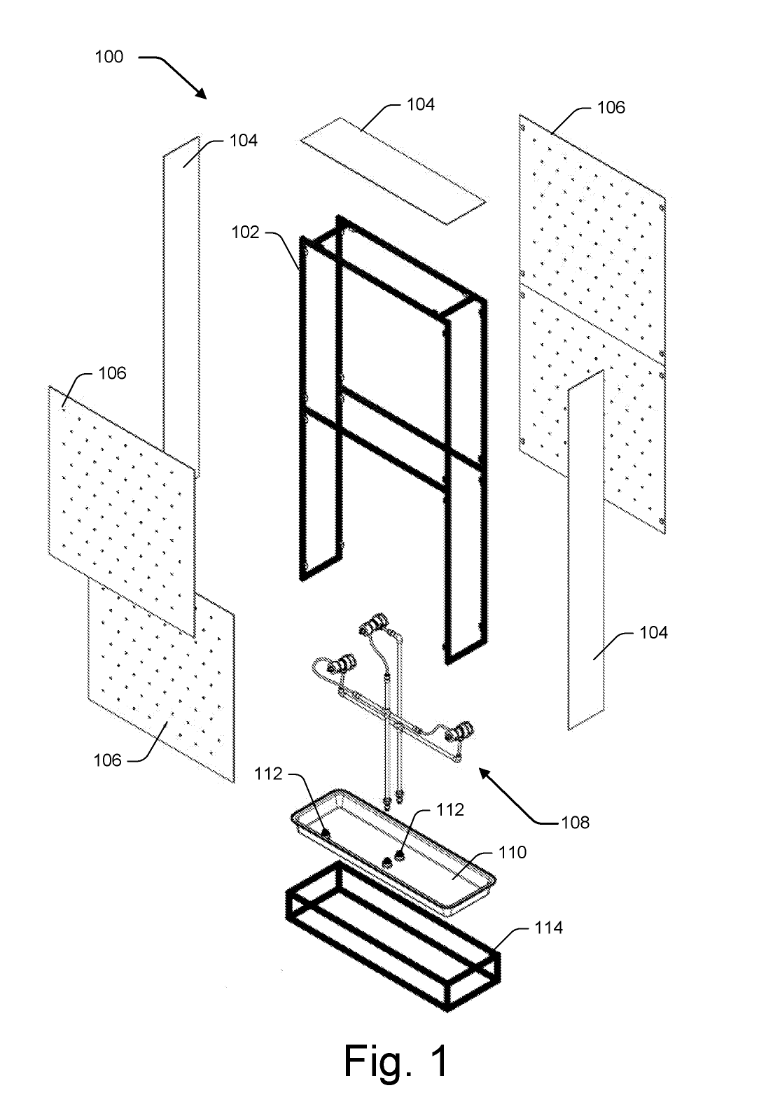

FIG. 1 illustrates an exploded view of an exemplary embodiment of an aeroponic cultivating system 100 having a frame 102 that is configured to carry auxiliary panels 104 and one or more growing panels 106. The auxiliary panels 104 and growing panels 106 may be attached to the frame 102 to enclose the frame 02 and define an aeroponic chamber within the enclosed frame 102. A nozzle assembly 108 is configured to reside within the aeroponic chamber of the frame 102 and provide an aqueous solution to the plants carried by the growing panels 106. A reservoir 110 is positioned generally below the nozzle assembly 108 and may have one or more fittings 112 for providing a fluid flow path to the nozzle assembly 108. The reservoir 110 may collect any moisture or condensation that collects within the aeroponic chamber and migrates by gravity to the reservoir 110. However, because of the fine atomization of the nutrient rich solution, there should be very little condensation or water that makes its way to the reservoir 110.

A lower frame 114 may be provided to support the reservoir 110 and provide a stable base for the frame 102. The lower frame 114 may be configured to allow movement or repositioning of the aeroponic cultivating system 100 such as by having wheels, or by being configured to allow a forklift, hand truck, pallet jack, or some other moving equipment, such as traditional warehouse moving equipment including mobile-robotic systems, to engage with the lower frame 114 and relocate the aeroponic cultivating system 100.

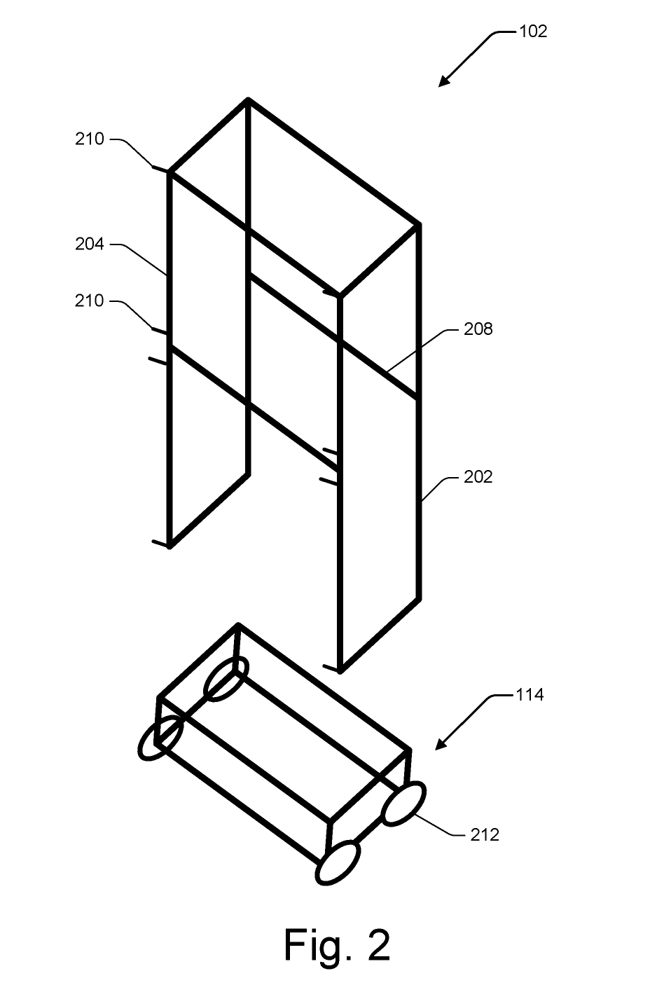

FIG. 2 illustrates on example of a frame 102 and a lower frame 114. The frame 102 is preferably configured to provide sufficient support for a plurality of growing panels 106 while still allowing the frame 102 to be moved. To this end, in some embodiments, the frame may be formed of metal or a metal alloy such as aluminum or steel, or may be suitably formed of a polymeric material, such as polyvinyl chloride (PVC) or acrylonitrile butadiene styrene (ABS), or other suitable material. In some embodiments, the frame is formed of an extruded, hollow material, and may therefore be formed of tubular material. This provides strength while allowing the frame to remain relatively light.

The components that make up the frame 102 may be secured together by any suitable attachment method, such as welding, gluing, fasteners, connectors, or fittings. In some embodiments, the frame 102 is formed of a first side 202 and a second side 204. The first side 202 and second side 204 may have a generally rectangular shape and may be connected by one or more upper cross members 206, intermediate cross members 208, or lower cross members (not shown). In some embodiments, the frame 102 resembles a cuboid in that there may be 5 or 6 rectangular sides. Of course, the frame geometry may form any suitable shape that is capable of supporting the growing panels 106 as described herein.

In some embodiments, the frame 102 defines a height that is greater than its width. By utilizing a frame 102 that is taller than it is wide, the frame 102 will provide for a vertical garden while maintaining a comparatively small footprint. In some instances, the frame 102 is configured with hooks 210 configured to engage with the growing panels 106 to support the growing panels 106 on the frame 102. The hooks 210 may be configured to engage with holes in the growing panel 106 to support the growing panel 106 while allowing for easy removal of the growing panel 106 from the frame, such as for cleaning the growing panel 106, harvesting the crops, or transporting the growing panel 106, such as from a growing location to a retail location.

The lower frame 114 may be generally cuboid in shape, with six sides that are generally rectangular. The lower frame 114 may be configured to support the reservoir 100, such as by providing an appropriate spacing for the reservoir to rest on the structural members that make up the lower frame 114.

The lower frame 114 may attach to the frame 102 by any suitable method. For example, the frame 102 and lower frame 114 may be connected with mechanical fasteners. Alternatively, the frame 102 and lower frame 114 may be formed integrally in a way that they are not easily separable, such as by welding, gluing, or some other more permanent way of connection. In yet another embodiment, the frame 102 is supported by the lower frame 114 without any attachment mechanism which facilitates easy separation of the frame 102 and lower frame 114 as desired.

In some embodiments, the lower frame 114 includes wheels or casters 212 that allow the lower frame 114 to be repositioned with relative ease. The lower frame 114 may also be configured to cooperate with traditional warehouse material handling equipment, such as pallet jacks, forklifts, hand trucks, robotic fulfillment equipment and the like to allow the lower frame 114 and frame 102 to be repositioned.

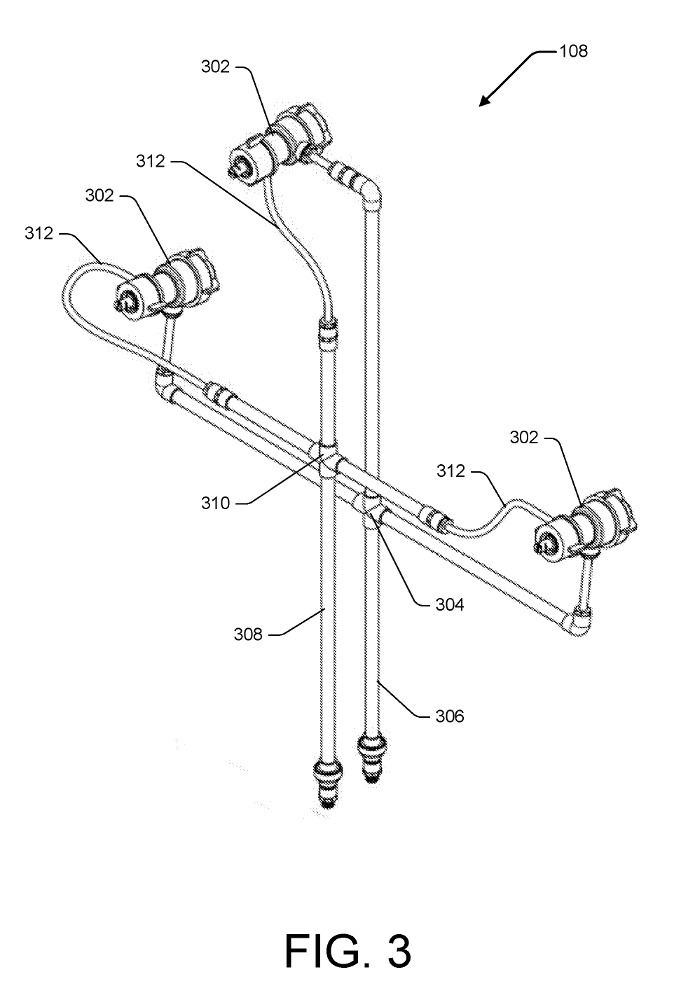

FIG. 3 shows one example of a nozzle assembly 108. In some embodiments, the nozzle assembly 108 includes one or more nozzles 302 configured to atomize a solution. The nozzles 302 may be any suitable nozzle, such as a surface-impingement nozzle, spillback nozzle, ultrasonic atomizer, compound nozzle, or any other suitable nozzle configuration that allows for desired atomization properties of the nutrient rich solution. The nozzles 302 may be supplied with a nutrient rich solution through a liquid manifold 304. As shown, a liquid mainline 306 may be connected to a supply of nutrient rich solution and include a liquid manifold 304 to distribute the solution to the connected nozzles 302. In some embodiments, the solution may be pressurized, such as by providing the solution in a pressurized tank, or by relying on a pump to force the solution through the mainline 306 and liquid manifold 304. In some of the embodiments in which the fluid is pressurized, the delivery system may be an airless spray system in which the pressurized fluid is atomized by the nozzles 302 and does not rely on pressurized air to assist with atomization or delivery of the nutrient rich solution. While the description uses the term “spray” to describe atomization and delivery of the nutrient rich solution, it should be understood that the broad term “spray” includes other forms of atomization and fluid delivery, such as, for example, misting, fogging, ultrasonic atomization, and other suitable spray technologies and techniques for creating fine nutrient rich water droplets.

According to other embodiments, pressurized air is used to aid in atomization and/or delivery of the nutrient rich solution. An air mainline 308 may supply pressurized air through an air manifold 310 and to the nozzles 302 via air lines 312. The nozzles 302 may be high-volume low-pressure (HVLP) nozzles configured to atomize the solution at relatively low air pressures, such as less than about 30 psi or less than about 40 psi. In other embodiments, the nozzles 302 may be selected to require a relatively high air pressure, such as above about 45 psi, 50 psi, 60 psi, 75 psi, 90 psi, and in some embodiments up to 115 psi or more to aid in very fine atomization and delivery of the nutrient rich solution. Additionally, a relatively high air delivery pressure, such as above about 45 psi or 60 psi, will aid in ensuring that the nozzles 302 remain clog free throughout their life cycle, as the blast of air will tend to clear any nozzle obstructions. In some embodiments, the nozzles 302 are configured to deliver the nutrient rich solution in aqueous droplets from about 15 microns to about 50 microns in size, and in some embodiments, from about 30 microns to about 45 microns in size. Thus, the nozzles 302 deliver a very fine mist, which may be described as a fog, of nutrient rich solution to the root structures within the aeroponic chamber. In some embodiments, the nozzles 302 provide a fluid mist having droplet sizes averaging between 15 and 50 microns at an air pressure of above 60 psi. In other embodiments, the nozzles 302 provide a fluid mist having droplet sizes averaging between about 20 and 40 microns at an air pressure of above 45 psi. Of course, other droplet sizes are possible and are preferably selected so as to not saturate the root structure with liquid water and cause dripping water. Suitable droplet sizes include droplets that average above 15 microns, 20 microns, or 25 microns and average in some cases, average lower than about 50 microns, 40 microns, or 35 microns. A pressure regulator may be provided at each nozzle 302 to regulate the pressure provided thereto and each nozzle 302 may be further configured with a feedback system to alert of any malfunctions with the nozzle 302, such as a loss of air pressure, a loss of fluid pressure, or clogging of one or more orifices within the nozzle 302.

The nozzles 302 may further be selected and configured to provide a wide fan spray pattern to broadly distribute the nutrient rich solution to a large growing area. The nozzles 302 may be located and spaced in any configuration that provides for adequate misting of the root structure of the plants. For example, a nozzle density of a single nozzle 302 per growing panel 106 may be sufficient to adequately spray the roots of all the plants supported by the growing panel 106. Alternatively, a single nozzle 302 may be sufficient to adequately spray all the plants supported by multiple growing panels 106 supported by a frame 102. In those embodiments that define a substantially closed aeroponic chamber, a single nozzle 302, or a relatively small number of nozzles 302, may fill the aeroponic chamber with a fine mist of atomized nutrient rich solution sufficient to support the growth of many plants supported by the growing panels 106. Of course, any number of nozzles 302 may be deployed in any desirable configuration to provide adequate nutrition for the plants supported by the growing panels 106.

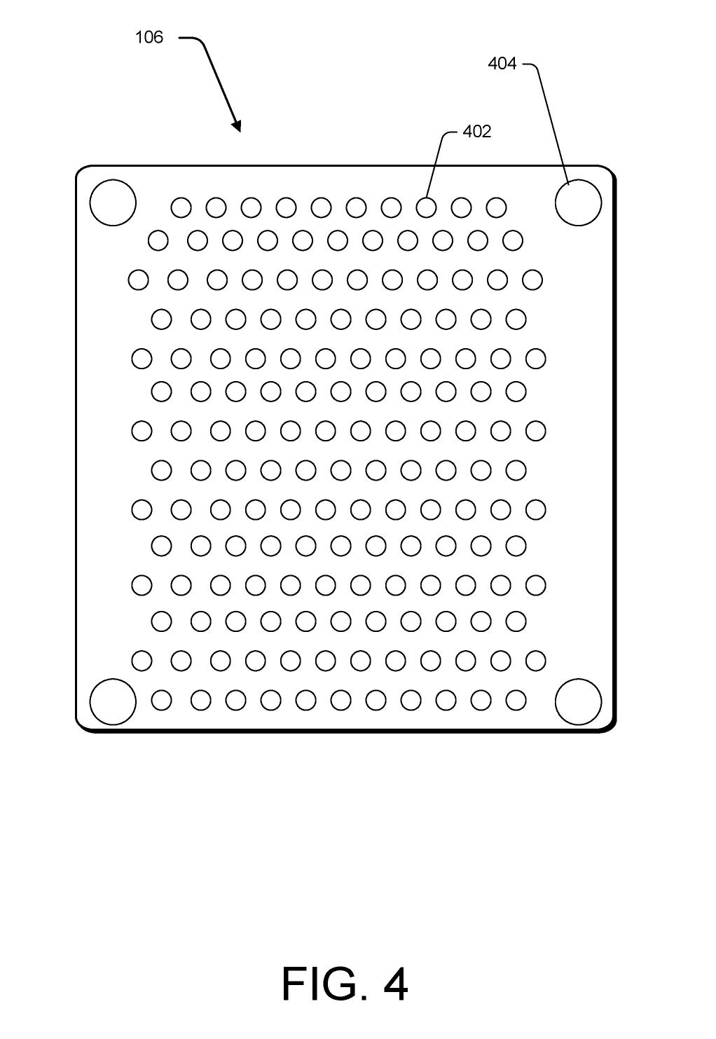

FIG. 4 illustrates one example of a growing panel 106. In one embodiment, the growing panel 106 is generally rectangular, and may be square, and is configured with plant site apertures 402 configured to support plants as they grow. The plant site apertures 402 may have any suitable shape, size, configuration, layout, and density on the growing panel 106 that is amenable to crop growth. For example, the plant site apertures 402 may be sized and spaced depending on the plant that will be supported by the growing panel 106. Indeed, a crop of basil plants may allow for a sizing and spacing of plant site apertures 402 that is much different than that required by a crop of lettuce plants and the growing panels 106 may be appropriately configured to support a variety of various crops.

The growing panel 106 may additionally be configured with mounting holes 404 that are configured to cooperate with the frame 102 to allow the growing panel 106 to be securely attached to the frame 102. In one example, the frame 102 is configured with protrusions, or hooks 210, that engage the mounting holes 404 of the growing panel 106 to removably hold the growing panel 106 securely to the frame 102.

In other embodiments, additional methods to attach the growing panel 106 to the frame 102 may include, for example, threaded fasteners to engage threaded holes in the frame, magnets built into the growing panel 106 and/or the frame 102 to allow a magnetic catch, hook and loop fastening systems, or other such systems for selectively removably attaching a growing panel 106 to the frame 102.

The growing panel 106 may be formed of any suitable material. However, in some embodiments, a chemically inert material is preferred to minimize any adverse interaction with the plants that it will support. Examples of suitable chemically inert materials may include polyethylene, stainless steel, metal composites, fluorocarbons and other crystalline thermoplastics, glass, and glass composites. However, in many embodiments, an opaque material is preferred for the growing panels 106 to block radiation from reaching the roots to inhibit fungal growth.

One particular advantage provided by the removable growing panels 106 described herein is their ability to go from farm to market while keeping the plant intact and alive. For example, when the crop is ready to be harvested, the growing panel 106 can be removed from the frame 102 and taken directly to the retail grocer or market without removing the plant from the growing panel 106. The growing panel 106 may be placed on an absorbent surface, such as a felt capillary mat that holds enough moisture to keep the root structure alive during transport. Accordingly, the consumer is able to harvest the crop at the point of purchase, which ensures that farm-grown produce may be kept fresh for the consumer, even where the produce has to travel great distances over a relatively long period of time. In fact, the growing panels 106 may be attached to a display frame at the point of purchase and the growing panels 106 may provide an attractive display of the crops, while allowing them to continue to grow and produce while at the point of sale. Once the crops are harvested, the growing panels 106 are able to be sterilized and reused.

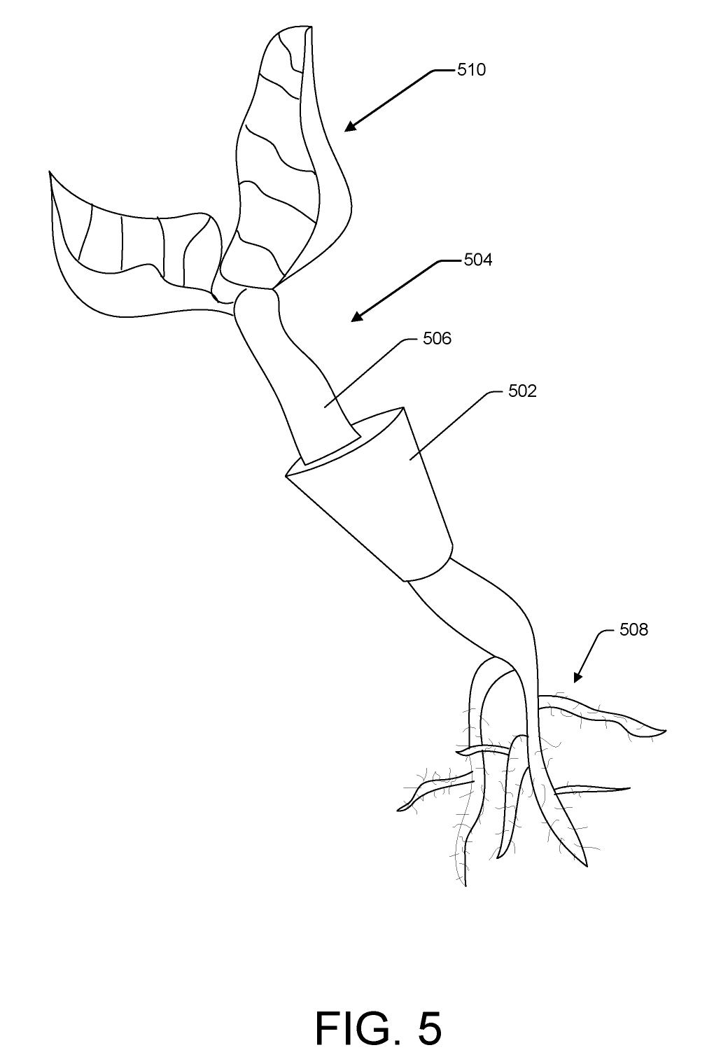

With reference to FIG. 5, a sheath 502 is shown that may be fitted to a plant 504, by surrounding the stalk 506, for example. In some embodiments, the sheath 502 is frustroconically shaped such that it will fit partially within one of the plant site apertures 402 formed in the growing panel 106. The sheath 502 is preferably inhibited from going all the way through the aperture 402, but rather, forms an interference fit, or friction fit, with the growing panel 106 so the plant 504 is held securely in the growing panel 106.

The sheath 502 may be formed of any suitable material, and in some embodiments, is formed of a closed cell foam. The sheath 502 may have an axial slit along its longitudinal axis, such that a cross section of the sheath 502 is generally C-shaped, which facilitates mounting or removing the plant 504 within the sheath 502. The root structure 508 of the plant 504 may be inserted into the plant site aperture 402 of the growing panel 106 until the sheath 502 contacts the edge of the plant site aperture 402 and inhibits the plant 504 from further insertion through the aperture 402. Thus, the root structure 508 is suspended on one side of the growing panel 106 where the nozzle assembly 108 is located, while the canopy 510 of the plant 504 remains on the other side of the growing panel 106 where radiation, such as sunlight or artificial light from growing lights, provides the energy necessary for photosynthesis.

The sheath 502 advantageously provides for fast and efficient removal of a plant 504 from the growing panel 106. In some instances, such as where a plant 504 may become diseased, it may be desirable to quarantine a plant 504, and the sheath 502 allows efficient removal of the plant 504 without disturbing the root structure 508 or the neighboring plants. Additionally, a sheath 502 that allows the entire plant 504 to be removed from the growing panel 106 allows a consumer to purchase an entire plant 504 at a retail location and then transplant the plant, such as into a traditional growing medium, such as soil, while minimizing transplant shock in the process.

In some embodiments, the growing panel 106 may be configured with a trellis, shelves, or other support structure for the canopy 510 of the plant 504 and any crops that could benefit by relieving stress caused by dangling from the plant. This type of supporting structure may allow plants 504 with larger or heavier crops to be grown with the disclosed aeroponic cultivation system 100.

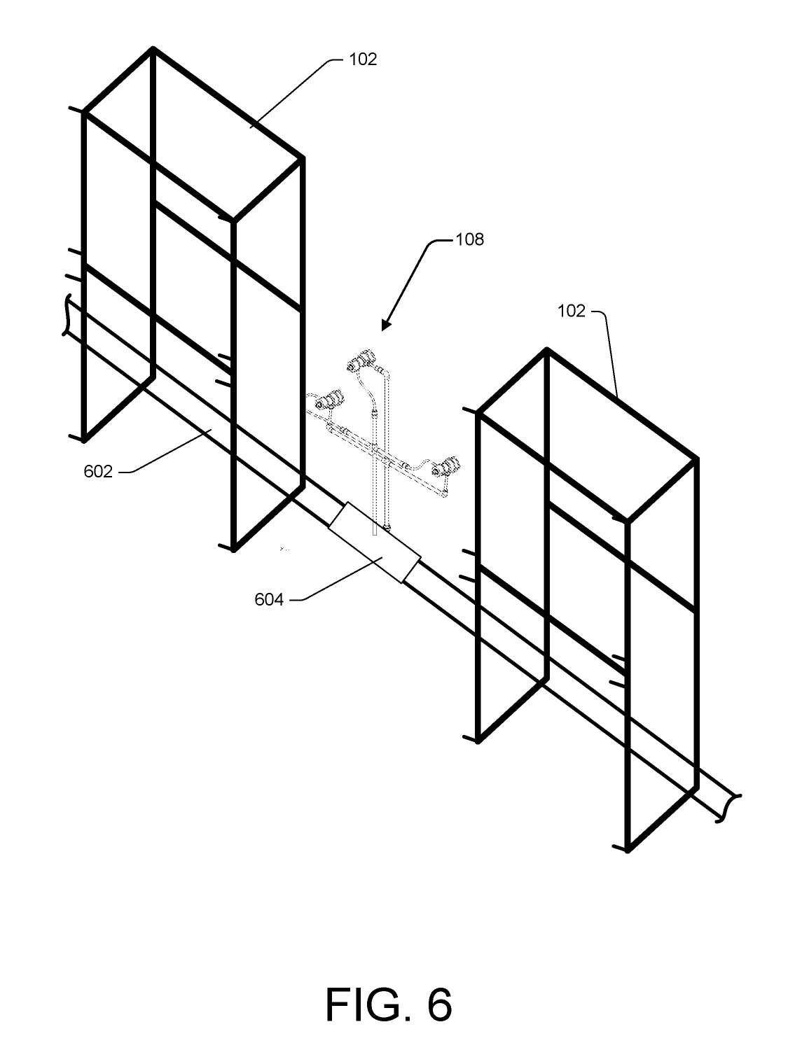

FIG. 6 shows one embodiment of a mobile nozzle assembly 108. A plurality of racks 102 may be positioned adjacent one another such as in a row. A mobile nozzle assembly 108 may be configured to travel from one frame 102 to another frame 102 to provide the nutrient rich solution to plants growing in growing panels 106 supported by the frames 102.

In some instances, a track 602 may extend from one frame 102 to another frame 102 and provide a pathway for the mobile nozzle assembly 108 to travel. The mobile nozzle assembly 108 may be a self-contained unit that carries a reservoir of nutrient rich solution with it to deploy on the plants supported at each frame 102. It may also carry a power source, such as a battery, to provide motion. Alternatively, the mobile nozzle assembly 108 may ride on a shuttle 604 or be configured with wheels that roll on a pathway 602 and one or more cables may pull the mobile nozzle assembly 108 along the pathway. In this case, the mobile nozzle assembly 108 need not be powered, but rather, can be free-wheeling along the pathway 602.

In those embodiments that employ a mobile nozzle assembly 108, the number of nozzles can be greatly reduced, which likewise reduces the setup cost and the likelihood of crop failure resulting from nozzle failure. A single nozzle 302 or nozzle assembly 108 can provide the nutrient rich solution to a large number of plants supported by one or more growing panels 106 situated in one or more frames 102.

In some embodiments that arrange frames 102 for a high-density vertical farm, the frames 102 may be positioned adjacent to one another and growing panels 106 may be attached to the frames 102 to define an aeroponic chamber that is relatively wide. For example, where a frame 102 is configured to hold two growing panels 106 that are approximately four feet wide by four feet high in a vertically stacked orientation, a single frame may define an aeroponic chamber within the frame that is roughly four feet wide by eight feet high and two feet deep, thus providing thirty-two square feet of vertical growing space. Additionally, both sides of the frame may be used to support growing panels 106, thus providing for sixty-four feet square feet of growing space from a single frame. The foot print of the frame 102 may only require eight square feet of floor space, thus resulting in a high-density vertical farm that realizes eight times the growing area when compared to traditional horizontally oriented farms.

Moreover, multiple frames may be placed adjacent to one another in a row, and with growing panels 106 attached to the frames 102, an aeroponic chamber may be defined that is as wide as the row of panels 106. As an example, ten frames 102 may be placed side by side, where each frame 102 is roughly four feet wide and eight feet high. By enclosing the space within the frames with growing panels 106, the aeroponic chamber may be forty feet wide by eight feet high, or roughly three hundred twenty square feet of growing space in a foot print that requires only eighty square feet of floor space. If the frames 102 support growing panels 106 on both sides, then the effective growing surface area is doubled to six hundred forty square feet while requiring the same eighty square feet of floor space.

Furthermore, the frames 102 may be stacked, such as on pallet racks, shelves, or directly supported by lower frames 102. Using the previous example, by stacking the frames 102 two high, the growing area may be doubled to a vertical growing area of one thousand two hundred eighty square feet while requiring only the original eighty square feet of floor space. Thus, it can be seen that high-density vertical farms are possible through the use of the novel systems and methods disclosed herein.

In a high-density vertical farm, as described, a mobile nozzle assembly 108 can provide nutrition to a large number of plants while minimizing the number of nozzles 302 required to maintain the crops. In many instances, the nozzles 302 do not need to continuously provide nutrition to the growing plants. For example, depending on the plant and the growing environment, the nozzle 302 may need to only provide a two-second spray every two or three minutes to maintain optimal growing conditions. Thus, a mobile nozzle assembly 108 can provide nutrition to a large number of plants by moving throughout a larger aeroponic chamber.

As disclosed herein, the aeroponic cultivation system 100 can rely on naturally occurring radiation from the sun or can alternatively or additionally utilize grow lights to provide artificial radiation. In some embodiments in which the sun is relied upon, it can be beneficial to move the frames with the sun to maximize the natural radiation available to the plants.

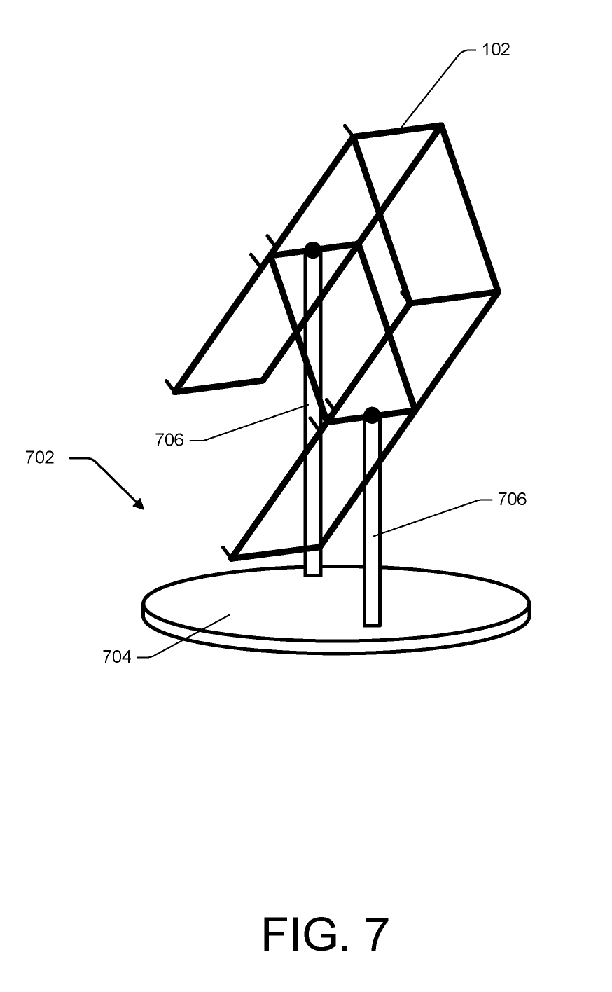

FIG. 7 illustrates an example of a solar tracking mount 702 for supporting and rotating a frame 102 to track the sun along its azimuth and elevation. A base platform 704 may be rotatable about a central vertical axis which allows the platform 704 and the frame 102 to track the sun's azimuth. Support arms 706 may be pivotally connected to the frame 102 to allow the frame 102 to be rotated about a horizontal axis so that one side of the frame 102 tracks the sun's elevation.

Of course, the illustrated embodiment only shows one possible way of tracking the sun. Other structures and methods are contemplated herein for maximizing the energy absorption in naturally radiated farms.

The frames 102 with the attached growing panels 106 may be positioned in any desired configuration, which may be determined by the available space within a farm. For example, in an indoor farm that has a high ceiling, the frames may be arranged vertically, such as on shelving units, or pallet racking, to allow the farm to maximize the available vertical space while occupying a relatively small footprint.

As one example, an indoor aeroponic farm may be established within a warehouse. Typical warehouse shelving may be used to support multiple vertically stacked arrays of frames 102 with growing panels 106. The automation described herein can be effectively utilized in a vertical farm configuration. For example, a mobile nozzle assembly 108 may track vertically in addition to horizontally to provide the nutrient rich solution to a vertical farm, or multiple mobile nozzle assemblies 108 may be provided to provide nutrients to plants supported by rows of frames 102. Additionally, warehouse moving equipment, such as, for example, pallet jacks, fork lifts, and robotic automation equipment can be used to position or move the frames 102 or collect or replace the growing panels 106.

In some embodiments, the growing panels 106 may be removed by automated equipment. This facilitates efficient swapping of growing panels 106 such as for harvesting of crops, quarantining of plants supported by a growing panel 106, inspection of the plants supported by the growing panel 106, or for shipment of the entire growing panel 106 to a grocer. Another growing panel 106 may replace the removed growing panel 106 to maintain the enclosure of the aeroponic chamber.

While the aeroponic cultivation system 100 disclosed herein has been disclosed with various features, systems, and subsystems, the disclosed combinations are not exhaustive and should not be limiting. For example, additional systems can be incorporated with the aeroponic cultivation system 100 to improve growing capacity, plant health, flowering, and yield. For example, biological subsystems can effectively be incorporated, such as heating and/or cooling sensors, pathogen inhibitors, effluent control systems, water purification, and nutrient sterilization.

Although the subject matter has been described in language specific to structural features and/or methodological acts, it is to be understood that the subject matter defined in the appended claims is not necessarily limited to the specific features or structure described. Rather, the specific features and structure are disclosed as exemplary forms of implementing the claims.

We claim:

1. A system comprising:
a frame defining a cuboid having at least a front side, a back side, a right side, a left side, and a top side, the frame defining a cavity;
a plurality of panels removably coupled to the frame to enclose the cavity to create an aeroponic chamber, the plurality of panels including at least a front panel, a back panel, a right side panel, a left side panel, and a top panel, wherein one or more of the plurality of panels are growing panels having one or more plant site apertures arranged in an array and sized to facilitate the insertion of individual plants such that roots of the individual plants are within the aeroponic chamber and a canopy of the individual plants are outside the aeroponic chamber; and
a fluid nozzle positioned within the aeroponic chamber, the fluid nozzle in fluid communication with an aqueous solution and in fluid communication with a source of compressed air and configured to atomize the aqueous solution into droplets of between about 20 microns and 50 microns by mixing the aqueous solution with the compressed air.

2. The system as in claim 1, wherein the compressed air is provided to the nozzle at a pressure above 60 psi.

3. The system as in claim 1, wherein the aqueous solution is pressurized for delivery to the fluid nozzle.

4. The system as in claim 1, wherein the fluid nozzle is moveable within the aeroponic chamber.

5. The system as in claim 4, further comprising a row of adjacent frames defining a continuous aeroponic chamber defined by a plurality of frames and a plurality of growing panels.

6. The system as in claim 4, further comprising a track defining a pathway, wherein the fluid nozzle is configured to engage the track and travel along the pathway.

7. The system as in claim 1, further comprising an engagement mechanism configured to engage and support the frame, the engagement mechanism configured to further engage with moving equipment for relocating the frame.

8. A vertical growing system comprising:
a first substantially planar growing panel configured with first apertures;
a second substantially planar growing panel configured with second apertures;
a frame having a first side configured to removably couple the first growing panel in a vertical orientation and a second side configured to removably couple the second growing panel in a vertical orientation spaced a horizontal distance away from the first growing panel, wherein the first growing panel and the second growing panel define an aeroponic chamber therebetween;
a fluid delivery system configured to deliver fluid and air to the aeroponic chamber, the fluid delivery system comprising a nozzle configured to atomize the fluid to a predetermined droplet size range and within a predetermined air pressure range.

9. The vertical growing system as in claim 8, wherein the fluid delivery system further comprises a fluid manifold that delivers fluid to the nozzle and an additional nozzle, and an air manifold that delivers compressed air to the nozzle and the additional nozzle at a pressure above 60 psi at the nozzle and the additional nozzle.

10. The vertical growing system as in claim 8, further comprising a pressure regulator at the nozzle for regulating air pressure at the nozzle.

11. The vertical growing system as in claim 8, further comprising a base frame configured to mount to the frame and provide mobility to the frame.

12. The vertical growing system as in claim 11, wherein the base frame comprises casters to allow the frame to be rolled from a first position to a second position.

13. The vertical growing system as in claim 11, wherein the base frame comprises a support structure configured to allow moving equipment to securely lift the base frame and the frame.

14. The vertical growing system as in claim 11, further comprising a reservoir supported by the base frame and disposed generally beneath the first growing panel and the second growing panel and configured to collect moisture within the aeroponic chamber.

15. The vertical growing system as in claim 14, further comprising a pressurized fluid source in communication with the fluid delivery system, and in further fluid communication with the reservoir for recirculating fluid collected within the aeroponic chamber to the pressurized fluid source.

16. The vertical growing system as in claim 11, further comprising a sheath configured to support a plant within one of the first apertures such that a root of the plant extends within the aeroponic chamber and a canopy of the plant extends outside the aeroponic chamber.

17. A method of vertical crop cultivation, comprising:
providing a growing panel having a first side and a second side and configured with at least one plant site aperture extending from the first side to the second side, the at least one plant site aperture configured for supporting a plant;
vertically mounting the growing panel on a frame, the second side of the growing panel defining an aeroponic chamber;
inserting a plant into the at least one plant site aperture such that a root of the plant extends within the aeroponic chamber and a canopy of the plant extends outside the aeroponic chamber, the plant being supported by the growing panel;
providing a nutrient rich atomized solution to the root of the plant within the aeroponic chamber;
delivering the growing panel and the plant supported by the growing panel to a merchant; and
displaying the plant supported by the growing panel, wherein the plant continues to grow while on display.

18. The method as in claim 17, wherein providing a nutrient rich atomized solution comprises spraying a nutrient rich solution through a nozzle at a pressure of above about 60 psi to form droplets smaller than 50 microns.

19. The method as in claim 17, further comprising removing the growing panel from the frame with the plant prior to delivering the growing panel and the plant to the merchant.

20. The method as in claim 17, further comprising cleaning the growing panel and inserting a second plant into one of the apertures.
